(19) United States
(12) Patent Application Publication
(10) Pub. No.: US 2020/0285929 A1
(43) Pub. Date: Sep. 10, 2020

(54) BIOMETRIC CARD WITH DISPLAY

(71) Applicant: Ziaur Rahman, Dhaka (BD)

(72) Inventors: Ziaur Rahman, Dhaka (BD); Dariusz Kaliszewski, Warsaw (PL); Michal Iwanicki, Dabrowa Chotomowska (PL); Kamil Grabowski, Lódz (PL)

(21) Appl. No.: 16/810,802

(22) Filed: Mar. 5, 2020

Related U.S. Application Data
(60) Provisional application No. 62/814,741, filed on Mar. 6, 2019.

(51) Int. Cl. G06K 19/077; G06K 19/07

(52) U.S. Cl. CPC G06K 19/07707; G06K 19/0723; G06K 19/0716

(57) ABSTRACT

The present invention is directed to a biometric card that provides biometric input and display output independent from the reader or terminal that is used to execute transactions. By embedding the biometric sensor in the smart card, the secure IC controls the process of biometric image collection and limits the risk of accepting biometric templates eavesdropped during previous authentications or accepting biometric templates collected from users without their knowledge. The biometric authentication may be further configured with a random or non-random set of instructions generated by the secure IC and communicated to the card user via the display. The smart card may further be configured for use with a plurality of card users.

### PRIORITY CLAIM

This application claims the benefit of priority from U.S. Patent Application No. 62/814,741 filed Mar. 6, 2019, the contents of which are incorporated herein by reference in their entirety.

### FIELD OF THE INVENTION

The present invention relates to biometric authentication in smart cards and, more particularly, to biometric cards with display that provide biometric input and display output independent from a reader or terminal that is used to execute transactions.

### BACKGROUND OF THE INVENTION

Existing biometric authentication in smart cards is frequently subject to replay attacks or impersonation. For example, smart cards that execute biometric matching (e.g., fingerprint match-on-card) cannot verify the origin of biometric data provided for matching. As a result, it is possible for unauthorized persons to collect the fingerprint of the card holder and present it later for verification by the smart card integrated circuit (IC) and thus access restricted functionalities or execute transactions on behalf of the card holder without his or her consent.

In another example, input and output data of transactions executed within the secure IC of the smart card are subject to modification or substitution by hardware and/or software outside the card (such as a payment terminal) and acting as human interfaces of the smart card. Using malicious software, unauthorized persons are able to generate transactions that are different from those actually sent to the smart card as part of smart card transactions. Lacking an independent communication interface, the smart card cannot reliably inform its holder about currently processed transactions. As a result, the holder is exposed to fraud because he or she may unintentionally authorize bank transfers using substituted recipient account numbers or amounts, create digital signatures of modified messages or documents, or the like.

Technological advances such as an increase in memory size and computing capabilities of secure ICs used in smart cards have opened up new possibilities for multi-application cards. However, the limited physical dimensions of the smart card make it difficult to present data required by different applications on its surface. Moreover, security and privacy constraints regarding data handled by different applications may prevent presenting data required by different applications on the card at the same time.

The computational capacity of secure ICs, as accepted by industry standards, is limited and generally insufficient to create biometric templates from the data generated by the biometric sensor.

### SUMMARY OF THE INVENTION

The present invention is directed to a biometric card with display that addresses the problems identified above by providing biometric input and display output independent from the reader or terminal that is used to execute transactions. By embedding the biometric sensor in the smart card, the secure IC controls the process of biometric image collection and limits the risk of accepting biometric templates eavesdropped during previous authentications or accepting biometric templates collected from users without their knowledge.

A display according to the present invention allows the card holder to verify the details of transactions being processed by the smart card secure IC. With the present invention, the display is driven directly by the secure IC and is therefore not vulnerable to any threats present in terminal-side software and hardware. Even if human interfaces provided by the transaction system cannot be fully trusted, display embedded in the smart card provides the ultimate verification of operations executed in secure IC.

The present invention separates the generation of a biometric template from the matching of such generated template against stored templates, thus allowing the template matching to be performed by the card's secure IC without the need for computational capacity associated with the generation of the template.

The display according to the present invention equally allows for specific instructions on how biometric information is to be collected using the biometric sensor on the card. In the case of a fingerprint sensor, the display may instruct a particular finger, a sequence of fingers, a specific alteration to the position of the finger or any other instructions that make the use of fake fingerprints extremely difficult. Similarly, in the case of other sensors (camera, microphone), the display may provide additional instructions on the recording of the biometric information (such as face, voice) to prevent the use of fake biometric data.

With the present invention, multi-application smart cards can utilize displays to present different data depending on the situation. If a single smart card has more than one function, e.g., identification (ID) document and driver's license, contents of the display can be changed when a specific application in the secure IC of the smart card is launched. In one preferred embodiment, e-paper display is used, which allows for permanent display even after powering down the smart card without additional battery usage.

With the present invention, a single card can store biometric information on more than one person and thus be authenticated by more than one person without jeopardizing the security of a transaction. Each person may have individualized authorizations in respect of the use of the card.

### BRIEF DESCRIPTION OF THE DRAWINGS

Preferred and alternative examples of the present invention are described in detail below with reference to the following drawings:

FIG. 1 presents a sample card layout according to one embodiment of the present invention. The location of specific elements can be adjusted to match specific requirements:

FIG. 2 presents dependencies between various physical components of the card according to different embodiments of the present invention.

FIG. 3 presents dependencies between various logical components of the card according to different embodiments of the present invention.

FIG. 4 presents process flow illustrating one of the possible usages of the biometric card with display according to different embodiments of the present invention.

### DETAILED DESCRIPTION OF THE PREFERRED EMBODIMENT

The body of the biometric card with display according to the present invention can be made of plastic, PVC, polycarbonate, or the like. In a preferred embodiment, the card body is made of polycarbonate to ensure maximum durability of the final product. This material can be used to manufacture cards with validity of ten years. Using polycarbonate allows implementation of the most sophisticated physical security features designed for ID documents as well. Plastic and PVC are less durable than polycarbonate and offer less physical security features, but in an alternative embodiment can be more economically effective in projects where long-term validity and high-end physical security is not required.

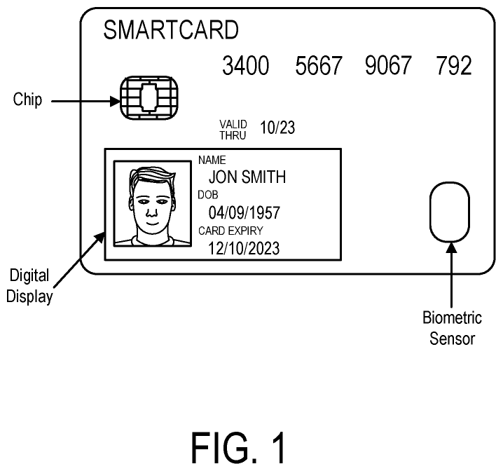

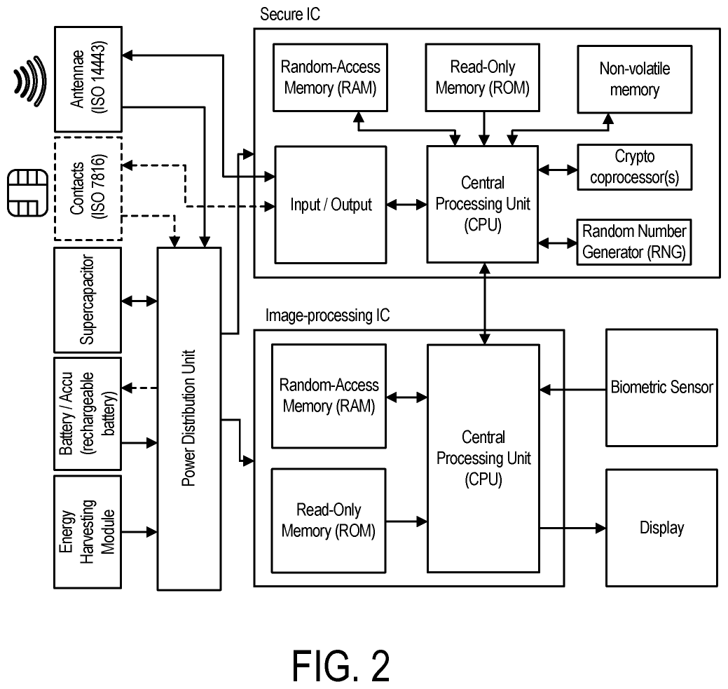

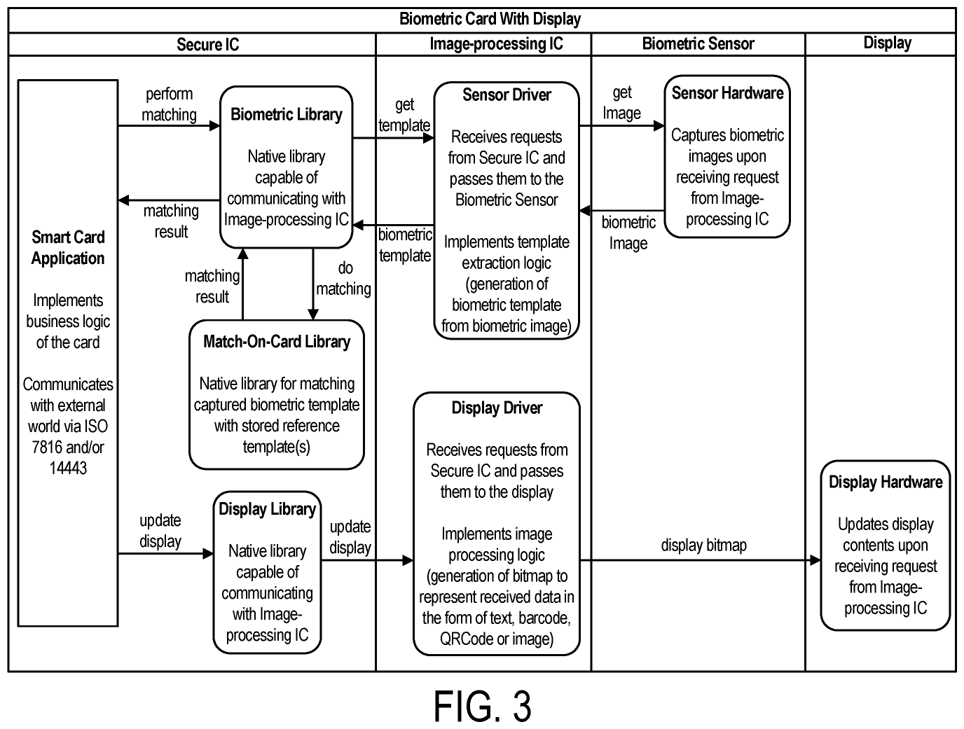

As shown with reference to FIGS. 1-3, a biometric smart card according to the present invention includes a biometric sensor, a secure IC and a digital display, embedded in a plastic, PVC, or polycarbonate card. In a preferred embodiment, the smart card includes the following elements:
Communication interface and external power source in the form of any combination of the following:
   ISO 14443 antennae (contactless card); and/or
   ISO 7816 contacts (contact card);
Internal power source in the form of any combination of the following:
   Supercapacitor for either fast or slow energy accumulation, used for additional power release when necessary;
   Battery or accumulator (rechargeable battery); and/or
   Energy Harvesting Module for generating power from ambient sources, e.g., heat, RF field (non-ISO14443 standard), vibrations, kinetic, etc.;
Power Distribution Unit distributing power from all available sources among secure IC, image-processing IC, biometric sensor, display and managing internal energy accumulation;
Secure IC (such as NXP SmartMX) containing the following:
   Central Processing Unit (CPU);
   Input/Output module;
   Random-Access Memory (RAM) for storing ephemeral data;
   Read-Only Memory (ROM) for storing code of applications and libraries;
   Non-Volatile memory (such as EEPROM or FLASH), e.g., for custom and/or log data storage;
   Crypto coprocessor(s); and
   Random Number Generator (RNG);
Image-processing IC (such as Cortex M4) containing the following:
   Central Processing Unit (CPU);
   Random-Access Memory (RAM) for storing ephemeral data; and
   Read-Only Memory (ROM) for storing code of applications and libraries;
Biometric sensor (such as fingerprint scanner); and
Display (such as e-Paper display).

In accordance with one embodiment of the present invention, secure IC and image-processing IC are combined into a single IC. In the preferred embodiment, secure IC and image-processing IC are separated to improve security of the card. Secure IC executes critical processes using sensitive data and is optimized for protecting confidentiality and integrity of the data. Available secure ICs are validated by worldwide-recognized certifications like Federal Information Processing Standards (FIPS) or Common Criteria, and use sophisticated security measures (such as sensors monitoring environment, redundant calculations executed by second core, etc.). Because image-processing IC is not directly involved in application critical processes, it can be optimized for performance in the field of image processing without compromising overall security of the invention. Communication between separated ICs can be handled by one of many standard microcontroller interconnection busses such as SPI, I²C, DART, or the like.

The biometric card with display according to the present invention can be contact, contactless or dual-interface. A contact card can be used by establishing physical connection with contacts located on the card's surface. It requires that the card is inserted into the reader or terminal. When the card is inserted into the reader, part of its surface becomes hidden. Biometric sensors and displays are preferably located on the visible part of the card to make it usable. A contactless card can be operated by putting the card within range of the reader's electromagnetic field, which is preferably approximately 5 to 10 centimeters. No part of the contactless card is obscured by the reader. Additionally, contactless communication is typically more efficient in terms of data transfer bandwidth. A dual-interface card is capable of using each of these two interfaces.

In a preferred embodiment, the card is contactless, which allows faster communication and does not limit the area where the display and biometric sensor can be located on the card. All communication is handled by a secure IC. The card may include other elements that may be used by secure IC and are used by the secure IC when needed.

According to the present invention, the power required for card operation is preferably delivered through card contacts or antenna, or is supplied from an internal power source (supercapacitor, battery), or provided by a power harvesting module from an ambient source. Supplying power in this manner is applicable for either contact or contactless smartcards. In a preferred embodiment, the image-processing IC is powered from the same source through software optimization to focus on energy-efficiency instead of performance. In accordance with one embodiment of the present invention, the card is powered by a separate internal source in the form of a supercapacitor or battery embedded into the card body. The battery is preferably capable of wireless charging, but may be otherwise configured to have sufficient capacity to last the estimated number of usages of the card, for example using a larger battery or through software optimization. Both the supercapacitor and battery can be charged by energy received via antennae or contacts. In an alternative embodiment, energy for the supercapacitor and battery can be obtained from a power harvesting module capable of generating electricity from ambient power sources such as heat, RF field, kinetic energy, or the like. In a preferred embodiment, the card is powered by a combination of all of the above-listed sources and uses a power distribution unit to achieve balance between supply and demand.

A biometric sensor of the card is activated upon explicit request from the secure IC. In a preferred embodiment, business logic is implemented by a smart card application installed in the secure IC. This application requires biometric authentication. A request from this application is preferably sent via a native biometric library to an intermediate image-processing IC. This library provides an API for smart card applications allowing calls for biometric verification. Upon receiving such a call, it accesses the communication interface to the intermediate IC and issues a request for a biometric template to be extracted. The intermediate IC, upon receiving a request from the biometric library, activates a biometric sensor and waits for a biometric image to be returned.

Various types of biometric sensors can be used, for example, a camera for collecting face images, an iris scanner, a fingerprint scanner, or the like. Such sensor is preferably capable of capturing an image of a specific biometric feature of a person. In the preferred embodiment, a biometric sensor is a fingerprint scanner.

After receiving image data from the biometric sensor, the intermediate IC transforms it into a biometric template, which is composed of distinct characteristics extracted from the biometric image. For fingerprints, these characteristics include minutiae data. Each minutia is a feature of a fingerprint described by its type (ridge ending, ridge bifurcation), orientation and coordinates. Other biometrics use proprietary information and encoding in biometric templates, for example, relative position, size and shape of eyes, nose, cheekbones and jaw can be extracted from a face image, while an iris can be described by a set of phase information about its pattern resulting from a Gabor wavelet transform of its image. In a preferred embodiment, the biometric template contains fingerprint minutiae encoded in compact format compliant to ISO 19794-2. The biometric template is returned to the secure IC for matching against a stored biometric reference template. Matching is preferably performed by a dedicated match-on-card library running within the secure IC, and the matching result is returned to the smart card application and is used by this application to grant or deny access to its functionalities. In a preferred embodiment, a standard match-on-card library offered by the secure IC manufacturer is used.

Similarly, the application installed in the secure IC can output data into the display. This feature can be used to inform the card holder about operations processed by the secure IC. Since this output is implemented within the smartcard completely, it does not rely on any third-party software or hardware using the smartcard, which adds to the security of the device. Data that is to be displayed is created or generated inside the secure IC and is sent to the intermediate image-processing IC, where it is transformed into bitmap and displayed on the card.

In an alternative embodiment, a smart card for authenticating a transaction may be configured with a biometric sensor configured to generate a biometric template and storage configured to store a plurality of predetermined biometric templates for use with a plurality of card users. In this embodiment, the secure IC generates either random or non-random instructions on how each separate card user may input biometric data used in generation of the biometric template using the biometric sensor, which instructions may be displayed to the user via the display. Once biometric data is input pursuant to the instructions, biometric authentication occurs, which involves matching a biometric template generated by the biometric sensor against stored biometric templates. Assuming a successful authentication, the transaction details authenticated as a result of the biometric authentication may be presented to the user via the display.

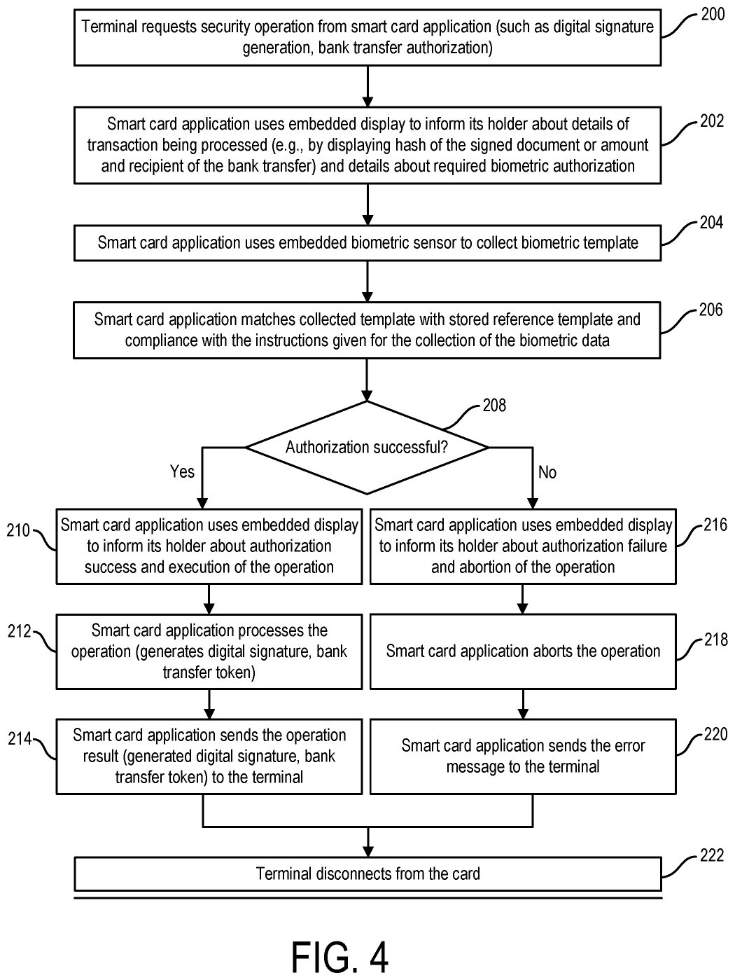

A process flow illustrating one of the possible usages of the biometric card with display is shown in FIG. 4. At block 200, a terminal requests security operation from a smart card application, such as a digital signature generation or bank transfer authorization. At block 202, the smart card application uses the embedded display to inform its holder about details of a transaction being processed, for example, by displaying a hash of the signed document or amount and recipient of the bank transfer, as well as about required biometric authorization. In one embodiment, specific instructions may be provided to the holder as to how biometric information is to be collected using the biometric sensor on the card. For example, in the case of a fingerprint sensor, the display may instruct a particular finger, a sequence of fingers, a specific alteration to the position of the finger or any other instructions that make the use of fake fingerprints extremely difficult. Similarly, in the case of other sensors (camera, microphone), the display may provide additional instructions on the recording of the biometric information (such as face, voice) to prevent the use of fake biometric data. At block 204, the smart card application uses the embedded biometric sensor to collect the biometric template. At block 206, the smart card application matches the collected template with the stored reference template, and compliance with the instructions are given for the collection of the biometric data.

At decision block 208, a determination is made as to the success of the authorization operation. If the authorization was successful, the logic proceeds to block 210, where the smart card application uses embedded display to inform its holder about authorization success and execution of the operation. At block 212, the smart card application processes the operation and, for example, generates a digital signature and a bank transfer token. At block 214, the smart card application then sends the operation result (e.g., the generated digital signature and bank transfer token) to the terminal.

On the other hand, if at decision block 208 the authorization has failed, the logic proceeds to block 216, where the smart card application uses embedded display to inform its holder about authorization failure and abortion of the operation. At block 218, the smart card application aborts the operation. At block 220, the smart card application sends the error message to the terminal.

Finally, at block 222, under either decisional situation, the terminal disconnects from the card.

It will be appreciated that these steps may be applied equally in an application involving a plurality of users with a single smart card, wherein multiple biometric templates may be generated and used for authentication.

In yet further embodiments, the secure IC may be configured to generate at least one of random or non-random instructions on how at least one card user may input biometric data used in generation of the biometric template using the biometric sensor. In either the single or plurality of user embodiments, the smart card may be configured to display the instructions to the card user via the display.

While the preferred embodiment of the invention has been illustrated and described, as noted above, many changes can be made without departing from the spirit and scope of the invention. Accordingly, the scope of the invention is not limited by the disclosure of the preferred embodiment.

The embodiments of the invention in which an exclusive property or privilege is claimed are defined as follows:

1. A smart card for authenticating a transaction, comprising:
a biometric sensor configured to generate a biometric template;
storage configured to store at least one predetermined biometric template;
a secure IC for transaction processing and biometric authentication, wherein biometric authentication comprises matching a biometric template generated by the biometric sensor against stored biometric templates; and
a display for presenting transaction details authenticated as a result of the biometric authentication.

2. The smart card of claim 1, wherein:
the secure IC generates at least one of random or non-random instructions on how a card user may input biometric data used in generation of the biometric template using the biometric sensor; and
the smart card communicates these instructions to the card user via the display.

3. A smart card for authenticating a transaction, comprising:
a biometric sensor configured to generate a biometric template;
storage configured to store at least one predetermined biometric templates for use with a plurality of card users;
a secure IC for transaction processing and biometric authentication, wherein biometric authentication comprises matching a biometric template generated by the biometric sensor against stored biometric templates; and
a display for presenting transaction details authenticated as a result of the biometric authentication.

4. The smart card of claim 3, wherein:
the secure IC generates at least one of random or non-random instructions on how at least one card user may input biometric data used in generation of the biometric template using the biometric sensor; and
the smart card communicates the instructions to the at least one card user via the display.

5. A method for authenticating a transaction at a transaction terminal initiated by a smart card having a biometric sensor, storage, a secure IC and a display, comprising:
requesting a security operation from the smart card by the transaction terminal;
displaying transaction details to a user via the display;
generating biometric template based on input user characteristics using the biometric sensor;
comparing the generated biometric template with predetermined biometric templates stored in the storage;
if the comparison returns a match indicating biometric authentication,
notifying the user of biometric authentication;
processing the transaction using the secure IC, wherein processing the transaction includes creating transaction operation data; and
transmitting the transaction operation data to the terminal; and
if the comparison does not return a match indicating biometric authentication,
notifying the user of failure of biometric authentication;
aborting the transaction; and
transmitting abortion of the transaction to the terminal.

6. The method of claim 5, further comprising:
generating via the secure IC at least one of random or non-random instructions on how the card user creates biometric used in generation of the biometric template using the biometric sensor; and
communicating the instructions to the card user via the display.

7. The method of claim 5, wherein:
generating biometric template based on input user characteristics using the biometric sensor comprises generating a template for a plurality of users; and
a plurality of predetermined biometric templates are stored in the storage for use in comparison involving a plurality of users.
